(19) United States
(12) Patent Application Publication
(10) Pub. No.: US 2019/0228285 A1
(43) Pub. Date: Jul. 25, 2019

(54) Configurable Convolution Neural Network Processor

(71) Applicant: The Regents of The University of Michigan, Ann Arbor, MI (US)

(72) Inventors: Zhengya ZHANG, Ann Arbor, MI (US); Chester LIU, Ann Arbor, MI (US)

(21) Appl. No.: 15/878,543

(22) Filed: Jan. 24, 2018

(51) Int. Cl. G06N 3/04

(52) U.S. Cl. CPC G06N 3/04; G06F 9/30101

(57) ABSTRACT

A configurable neuro-inspired convolution processor is designed as an array of neurons each operating in an independent clock domain. The processor implements a recurrent network using efficient sparse convolutions with zero-patch skipping for feedforward operations, and sparse spike-driven reconstruction for feedback operations. A globally asynchronous locally synchronous structure enables scalable design and load balancing to achieve 22% reduction in power. Fabricated in 40 nm CMOS, the 2.56 mm² inference processor integrates 48 neurons, a hub and an Open RISC processor. The chip achieves 718 GOPS at 380 MHz, and demonstrates applications in feature extraction from images and depth extraction from stereo images.

### GOVERNMENT CLAUSE

This invention was made with government support under grants HR0011-13-3-0002 and HR0011-13-2-0015 awarded by the U.S. Department of Defense/Defense Advanced Research Projects Agency (DARPA). The government has certain rights in this invention.

### FIELD

The present disclosure relates to a configurable convolution neural network processor.

### BACKGROUND

Neuro-inspired coding algorithms have been applied to various types of sensory inputs, including audio, image, and video, for dictionary learning and feature extraction in a wide range of applications including compression, denoising, super-resolution, and classification tasks. Sparse coding implemented as a spiking recurrent neural network can be readily mapped to hardware to achieve high performance. However, as the input dimensionality increases, the number of parameters becomes impractically large, necessitating a convolutional approach to reduce the number of parameters by exploiting translational invariance.

In this disclosure, a configurable convolution neural network processor is presented. The configurable convolution processor has several advantages: 1) the configurable convolution processor is more versatile than fixed architectures for specialized accelerators; 2) the configurable convolution processor employs sparse coding which produces sparse spikes, presenting opportunities for significant complexity and power reduction; 3) the configurable convolution processor preserves structural information in dictionary-based encoding, allowing downstream processing to be done directly in the encoded, i.e., compressed, domain; and 4) the configurable convolution processor uses unsupervised learning, enabling truly autonomous modules that adapt to inputs.

This section provides background information related to the present disclosure which is not necessarily prior art.

### SUMMARY

This section provides a general summary of the disclosure, and is not a comprehensive disclosure of its full scope or all of its features.

A configurable convolution processor is presented. The configurable convolution processor includes a front-end processor and a plurality of neurons. The front-end processor is configured to receive an input having an array of values and a convolutional kernel of a specified size to be applied to the input. The plurality of neurons are interfaced with the front-end processor. Each neuron includes a physical convolution module with a fixed size. Each neuron is configured to receive a portion of the input and the convolutional kernel from the front-end processor, and operates to convolve the portion of the input with the convolutional kernel in accordance with a set of instructions for convolving the input with the convolutional kernel, where each instruction in the set of instructions identifies individual elements of the input and a particular portion of the convolutional kernel to convolve using the physical convolution module.

In one embodiment, the front-end processor determines the set of instructions for convolving the input with the convolutional kernel and passes the set of instructions to the plurality of neurons. The front-end processor further defines a fixed block size for the input based on the specified size of the convolutional kernel and size of the physical convolution module, divides the input into segments using the fixed block size and cooperatively operates with the plurality of neurons to convolve each segment with the convolutional kernel. Convolving each segment with the convolutional kernel includes: determining a walking path for scanning the physical convolution module in relation to a given input segment, where the walking path aligns with center of each pixel of the convolutional kernel when visually overlaid onto the convolutional kernel and the walking path aligns with center of the input segment when visually overlaid onto the given input segment; and at each step of the walking path, computing a dot product between a portion of the convolutional kernel and a portion of the given input segment and accumulating result of the dot product into an output buffer.

In some embodiments, the front-end processor implements a recurrent neural network with feedforward operations and feedback operations performed by the plurality of neurons.

In some embodiments, neurons in the plurality of neurons are configured to receive a portion of the input during a first iteration and configured to receive a reconstruction error during subsequent iterations, where the reconstruction error is difference between the portion of input and a reconstructed input from a previous iteration. The neurons in the plurality of neurons may generate a spike when a convolution result exceeds a threshold, accumulates spikes in a spike matrix, and creates the reconstructed input by convolving the spike matrix with the convolutional kernel. The reconstructed input may be accompanied by a non-zero map, such that non-zero entries are represented by a one and zero entries are represented by zero in the non-zero map. Non-zero map of multiple reconstructed input segments may be accompanied by another non-zero map, forming a hierarchical non-zero map.

Further areas of applicability will become apparent from the description provided herein. The description and specific examples in this summary are intended for purposes of illustration only and are not intended to limit the scope of the present disclosure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram showing a hardware mapping of spiking convolutional sparse coding (sCSC) algorithm;

FIG. 2 shows how the proposed configurable convolution processor is applied to stereo images to extract depth information;

FIG. 3 is a block diagram showing a modular hardware architecture for the configurable convolution processor;

FIG. 4 is a diagram depicting an example implementation for the physical convolution module;

FIG. 5 is a flowchart providing an overview of the convolving process implemented by the configurable convolution processor

FIG. 6 is a diagram illustrating a method for scanning an input with an input segment;

FIG. 7A is a diagram illustrating a set of predefined paths which may be used to construct a walking path;

FIGS. 7B and 7C are diagrams illustrating an example walking path for a 5×5 kernel and an 8×8 input segment, respectively;

FIGS. 7D-7G are diagrams illustrating how the set of predefined paths are used to construct a walking path for a 5×5 kernel, a 7×7 kernel, a 9×9 kernel and a 11×11 kernel, respectively.

FIG. 8A is a diagram showing a 4×4 image convolved with a 3×3 kernel to produce a 2×2 output;

FIG. 8B is a diagram showing a walking path for the convolution shown in FIG. 8A;

FIGS. 8C-8K are diagrams illustrating the convolution along the nine steps of the walking path shown in FIG. 8B;

FIG. 9A shows entries in a NZ map indicating if at least one nonzero entry exists in a 2×2 block in the input;

FIG. 9B shows walking through the NZ map produces a sequence in which 0 means to skip;

FIG. 9C shows the five steps that are skipped in calculating a convolution;

FIG. 10A is a diagram showing token-based asynchronous FIFO;

FIG. 10B is a diagram showing FIFO full condition check for broadcast asynchronous FIFO; and

FIG. 11 is a graph showing chip power measurement result of feature extraction task and depth extraction task.

Corresponding reference numerals indicate corresponding parts throughout the several views of the drawings.

### DETAILED DESCRIPTION

Example embodiments will now be described more fully with reference to the accompanying drawings.

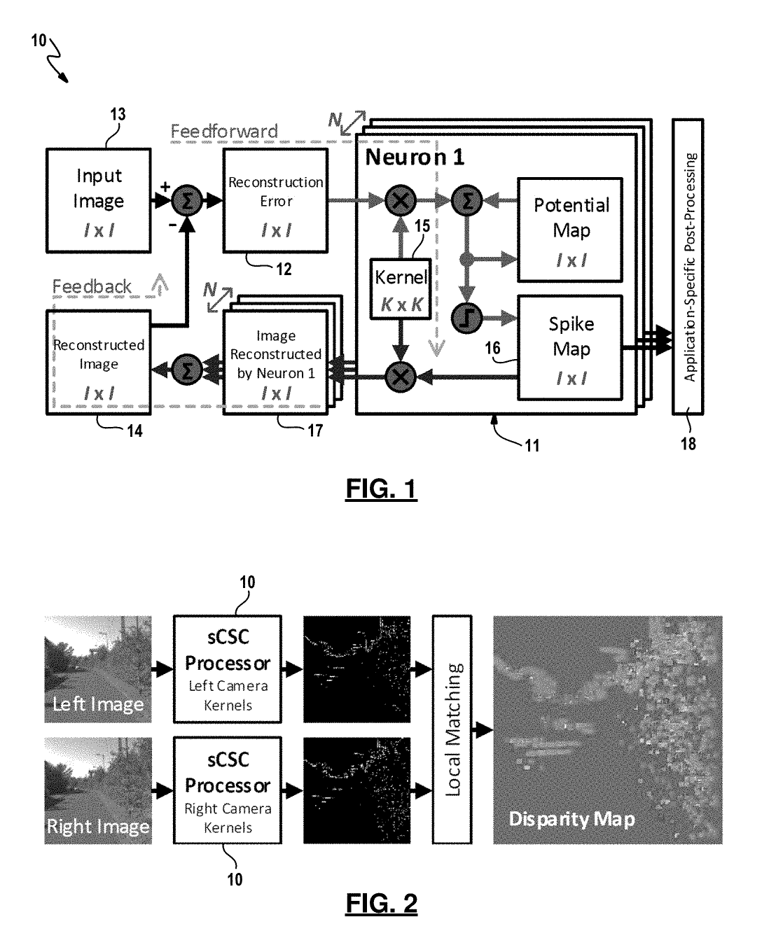

FIG. 1 illustrates an arrangement for a spiking convolutional sparse coding algorithm on the configurable convolution processor. The configurable convolution processor 10 is comprised of an array of neurons 11 as the compute units that perform configurable convolutions. In this arrangement, the configurable convolution processor 10 employs sparse coding. While reference is made throughout this disclosure to the use of sparse coding, it is readily understood that the broader aspects of this disclosure are not limited to the use of sparse coding.

In the above arrangement, the configurable convolution processor 10 implements recurrent networks by iterative feedforward and feedback. In a feedforward operation, each neuron convolves its input or reconstruction errors 12, i.e., the differences between the input 13 and its reconstruction 14, with a kernel 15. The convolution results are accumulated, and spikes are generated and stored in a spike map 16 when the accumulated potentials exceed a threshold. In a feedback operation, neuron spikes are convolved with kernel 15 to reconstruct the input. Depending on application, 10 to 50 iterations are required to complete one inference. The inference output, in the form of neuron spikes, are passed to a downstream post-processor 18 to complete various tasks.

For demonstration, a configurable convolution processor chip is built in 40 nm CMOS. The configurable convolution architecture is more versatile than fixed architectures for specialized accelerators. The design optimally exploits the inherent sparsity using zero-patch skipping to make convolution up to 40% more efficient than the state-of-the-art constant-throughput zero masking convolution. A sparse spike-driven approach is adopted in feedback operations to minimize the cost of implementing recurrence by eliminating multipliers. In this example, the configurable convolution processor contains 48 convolutional neurons with configurable kernel size up to 15×15, which are equivalent to 10,800 non-convolutional neurons in classic implementations. Each neuron operates at an independent clock and communicates using asynchronous interfaces, enabling each neuron to run at the optimal frequency to achieve load balancing. Going beyond conventional feature extraction tasks, the configurable convolution processor 10 is applied to stereo images to extract depth information as illustrated in FIG. 2. Although an imaging application is demonstrated in this disclosure, the configurable convolution processor is input-agnostic and can be applied to any type of input.

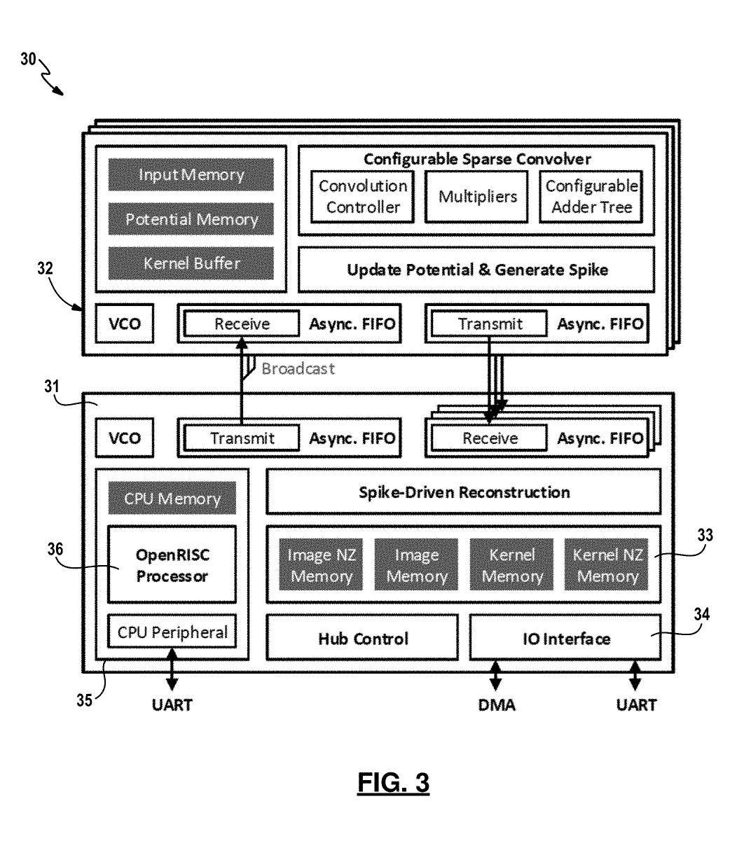

To implement a recurrent neural network for sparse coding, a modular hardware architecture is designed as shown in FIG. 3, where the feedforward operations are distributed to neurons, and the neuron spikes are sent to a central hub for feedback operations. The sparse neuron spikes make it possible to deploy efficient asynchronous interfaces and share one hub for feedback operations.

In an example embodiment, the modular hardware architecture 30 for the configurable convolution processor is comprised of a front-end processor, or hub, 31 and a plurality of neurons 32. The front-end processor 31 is configured to receive an input and a convolution kernel of a specified size to be applied to the input. In one example, the input is an image having an array of values although other types of inputs are contemplated by this disclosure. Upon receipt of the input, the front-end processor 31 determines a set of instructions for convolving the input with the convolution kernel and passes the set of instructions to the plurality of neurons.

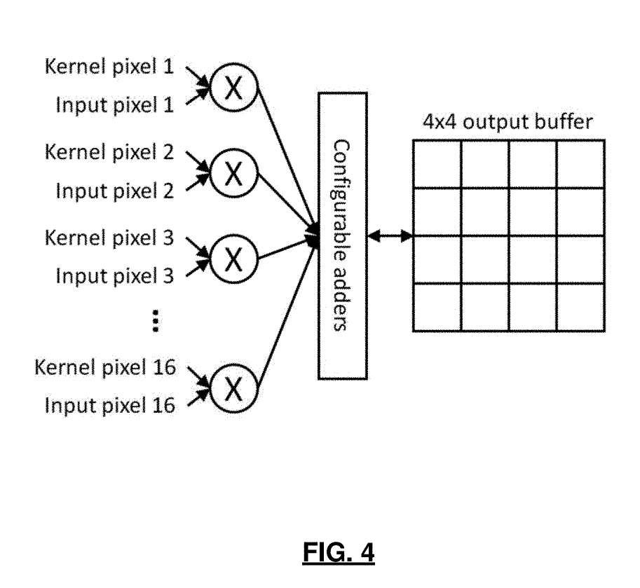

A plurality of neurons 32 are interfaced with the front-end processor 31. Each neuron 32 includes a physical convolution module implemented in hardware. The physical convolution module can perform a 2-dimensional (2D) convolution of a fixed size Sₚ×Sₚ. In the example embodiment, the physical convolution size is 4×4. It follows that the physical convolution module includes 16 multipliers, 16 output buffers and a group of configurable adders as seen in FIG. 4. The source and destination of the adders are configurable to perform different kinds of accumulation. Other sizes of the physical convolution module, including 1D, 2D or multi-dimensional, also fall within the scope of this disclosure. In some instances, the size of the physical convolution module may be bigger than the convolutional kernel.

Each neuron 32 is configured to receive a portion of the input and a convolution kernel of a specified size from the front-end processor 31. Each neuron in turn operates to convolve the portion of the input with the convolution kernel in accordance with the received set of instructions for convolving the input with the convolution kernel, where each instruction in the set of instructions identifies particular pixels or elements of the input and a particular portion of the convolution kernel to convolve using the physical convolution module.

In performing a feedforward operation, a neuron convolves a typically non-sparse input image (in the first iteration) or sparse reconstruction errors (in subsequent iterations) with its kernel. The feedforward convolution is optimized in three ways: 1) highest throughput for sparse input by exploiting sparsity, 2) highest throughput for non-sparse input by fully utilizing the hardware, and 3) efficient support of variable kernel size. To achieve high throughput and efficiency, a sparse convolver can be used to support zero-patch skipping as will be described in more detail below. To achieve configurability, variable-sized convolution is divided into smaller fixed-sized sections and a traverse path is designed for the physical convolution module to assemble the complete convolution result. The design of the configurable sparse convolution is described further below.

In one embodiment, each neuron supports a configurable kernel of size up to 15×15 using a compact latch-based kernel buffer, and variable image patch size up to 32×32. An input image larger than 32×32 is divided into 32×32 sub-images that share overlaps to minimize edge artifacts.

In a feedback operation, neuron spikes are convolved with their kernels to reconstruct the input image. A direct implementation of this feedback convolution is computationally expensive and would become a performance bottleneck. Taking advantage of the binary spikes, all multiplications in this convolution are replaced by additions. The design also makes use of the high sparsity of the spikes (typically >90% sparsity) to design a sparsely activated spike-driven reconstruction to save computation and power. This design is also detailed below.

With continued reference to FIG. 3, the front-end processor 31 contains a kernel memory, and a multi-banked image memory 33 that provides single-cycle read-accumulate-write capability. An image nonzero (NZ) memory is used to identify NZ entries in the reconstructed image to support sparse convolutions. The front-end processor 31 simultaneously broadcasts reconstructed image and its NZ map and receives spikes from neurons to ensure seamless feedforward and feedback operations without idling the hardware. The design of the asynchronous interfaces between the front-end processor 31 and the neurons 32 is described below. In an example embodiment, the front-end processor 31 uses a 16-bit bi-directional DMA interface 34 for data I/O, and a UART interface 35 for configuration. In the embodiment, an OpenRISC processor 36 is integrated on chip, and it can be tasked with on-chip learning and post-processing.

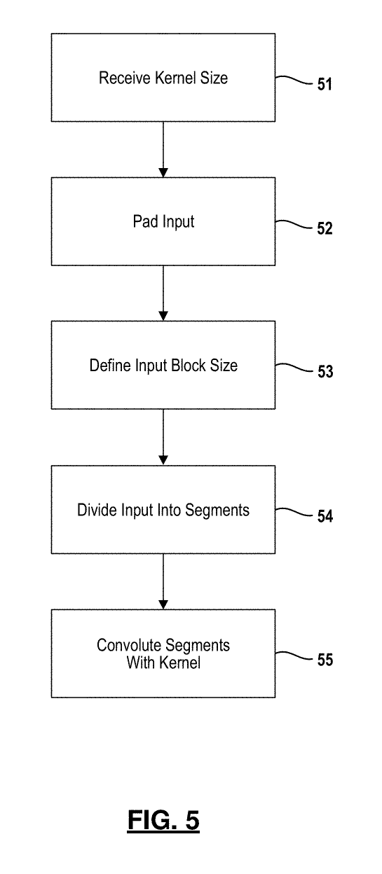

FIG. 5 provides an overview of the convolving process implemented by the configurable convolution processor 10. The size of the convolutional kernel Sₖ×Sₖ is specified as an input as indicated at 51. In the example embodiment, the configurable convolution processor 10 computes the convolution for any odd kernel size greater than or equal to 5×5; that is, 5×5, 7×7, 9×9 and so on. Additionally, the width of the overall input must be (Sₖ+Sₚ−1)+N_{w}×Sₚ; and the height of the overall input must be (Sₖ+Sₚ−1)+Nₕ×Sₚ, where N_{w} and Nₕ are integers. With N_{w}=2 and Nₕ=1, the size of the overall input is 16×12 in the example embodiment. In the event the input size results in a fractional N, the input needs to be padded at 52 with rows and/or columns of zeros to achieve the requisite size.

Next, the input block size is defined at 53 based on the kernel size and the size of the physical convolution module. Specifically, the input block size is set to (Sₖ+Sₚ−1)×(Sₖ+Sₚ−1). In the example embodiment, this equates to an input block size of 8×8.

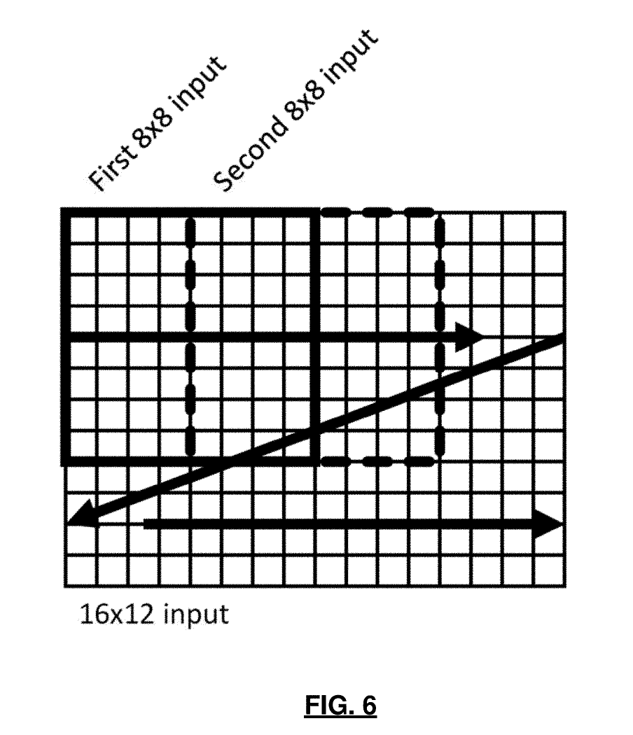

Lastly, the input is convolved with the convolutional kernel. In most instances, the size of the overall input is much larger than the input block size. When the size of the overall input is greater than the input block size, then the input is divided into segments at 54, such that each segment is equal to the input block size or a set of segments can be combined to match the input block size, and each segment or a set of segments is convolved with the convolutional kernel at 55. The segments may or may not overlap with each other. For example, starting from the top left corner, convolve a first segment with the convolutional kernel. Next, move Sₚ columns to the right (e.g., 4) and convolve this second segment with the convolutional kernel as shown in FIG. 6. Continue moving right and repeating convolution until reaching the right edge of the overall input. Return to the left edge of the overall input and convolve the convolutional kernel with the segment Sₚ rows below the first segment. Repeat these steps until all of the segments in the overall input have been processed. Other methods for the scanning the overall input are also contemplated by this disclosure.

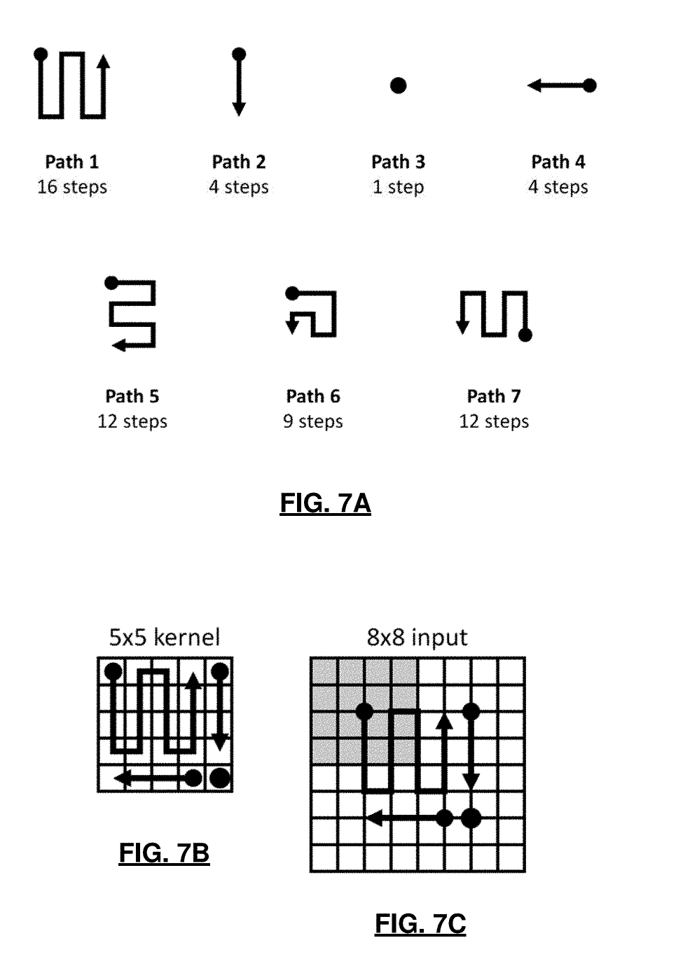

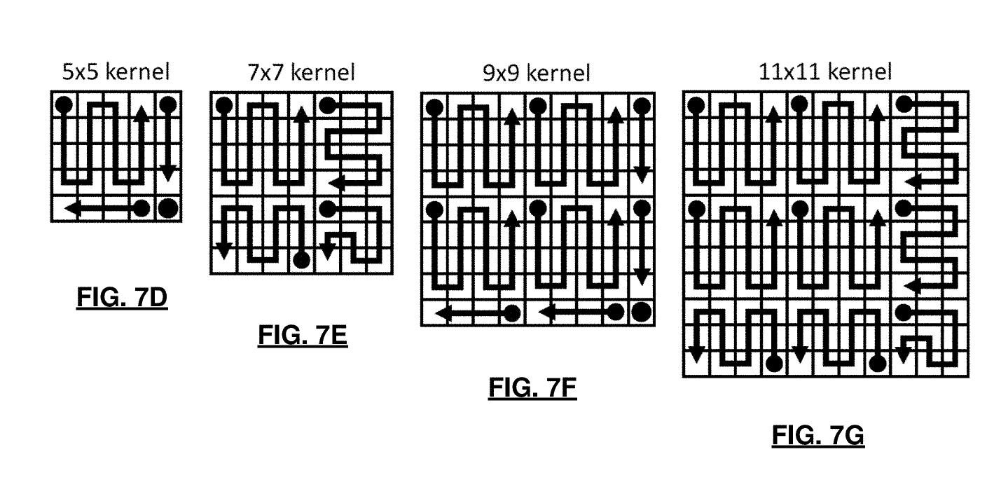

Convolving a given segment of the input with the convolutional kernel is described in relation to FIGS. 7A-7G. First, a walking path for scanning the physical convolution module in relation to a given input segment is determined. In an example embodiment, the walk path is constructed from a set of predefined paths. An example set of predefined paths is seen in FIG. 7A. From the set of predefined paths, a walking path is constructed. Specifically, the walking path is designed such that the walking path aligns with center of each pixel of the convolutional kernel when visually overlaid onto the convolutional kernel as seen in FIG. 7B and the walking path aligns with center of the input segment when visually overlaid onto the given input segment as seen in FIG. 7C. FIGS. 7D-7G illustrate how the set of predefined paths are used to construct a walking path for a 5×5 kernel, a 7×7 kernel, a 9×9 kernel and a 11×11 kernel, respectively. For these examples, it is readily understood how a walking path can be constructed for larger sized kernels.

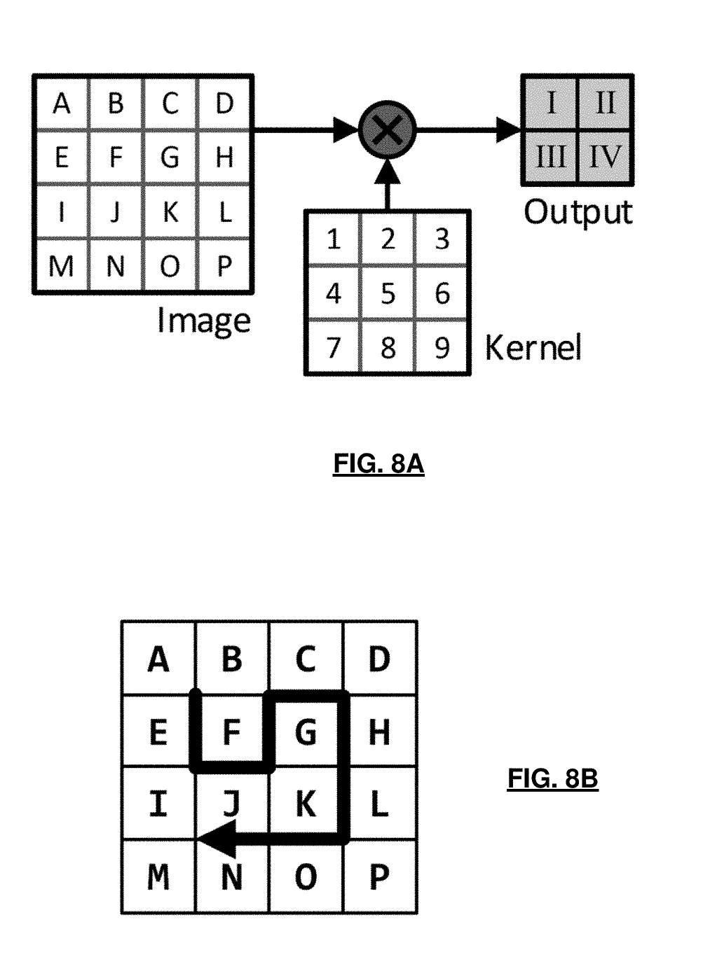

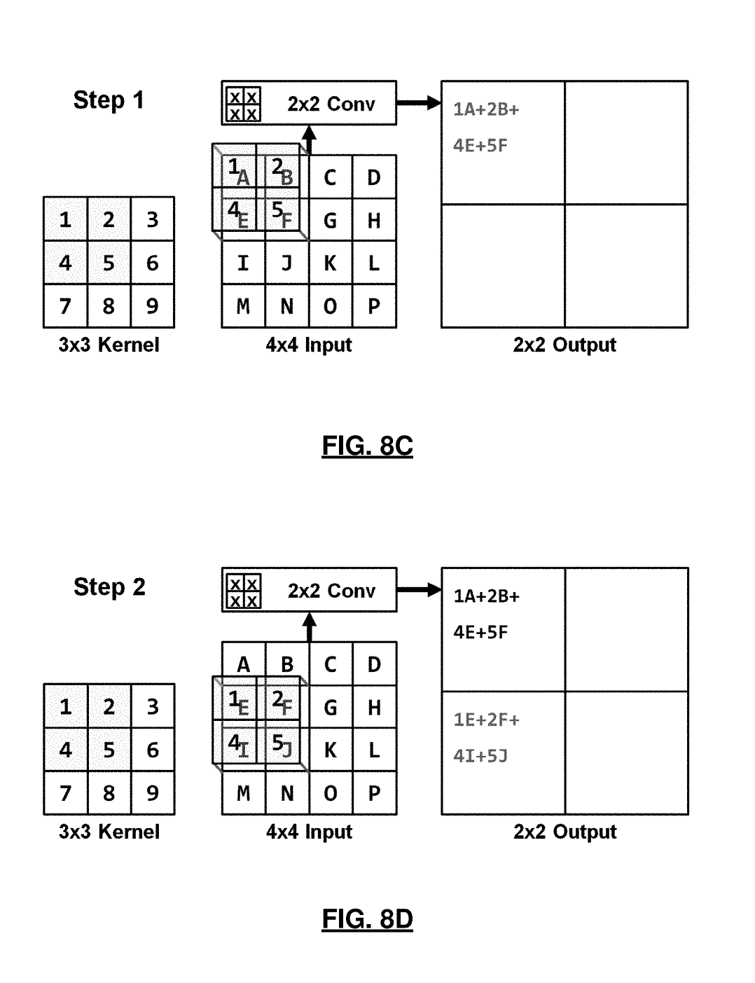

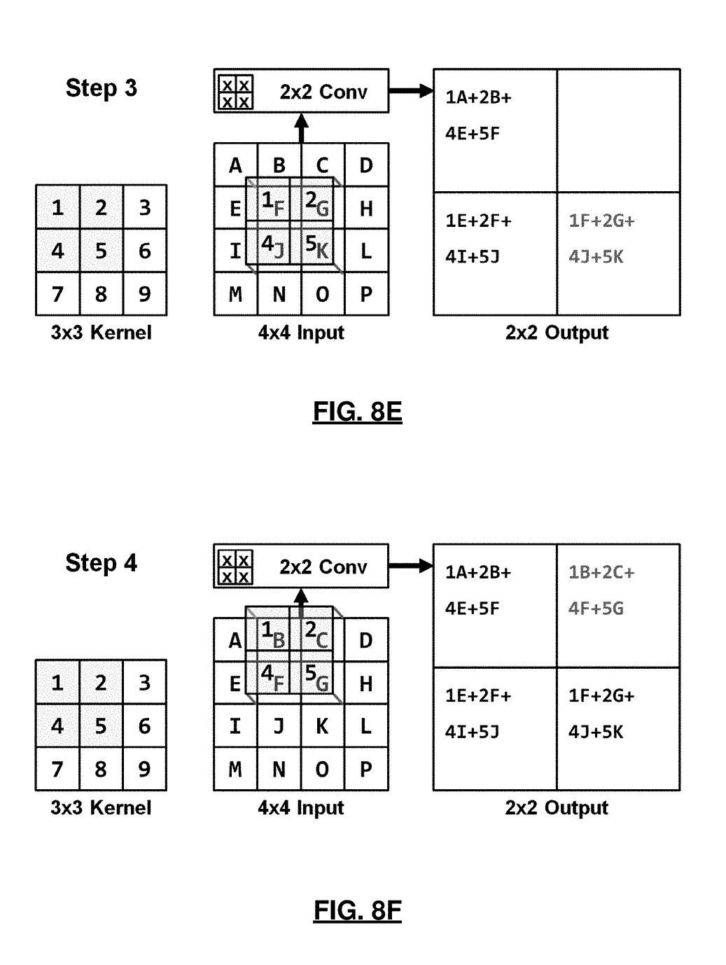

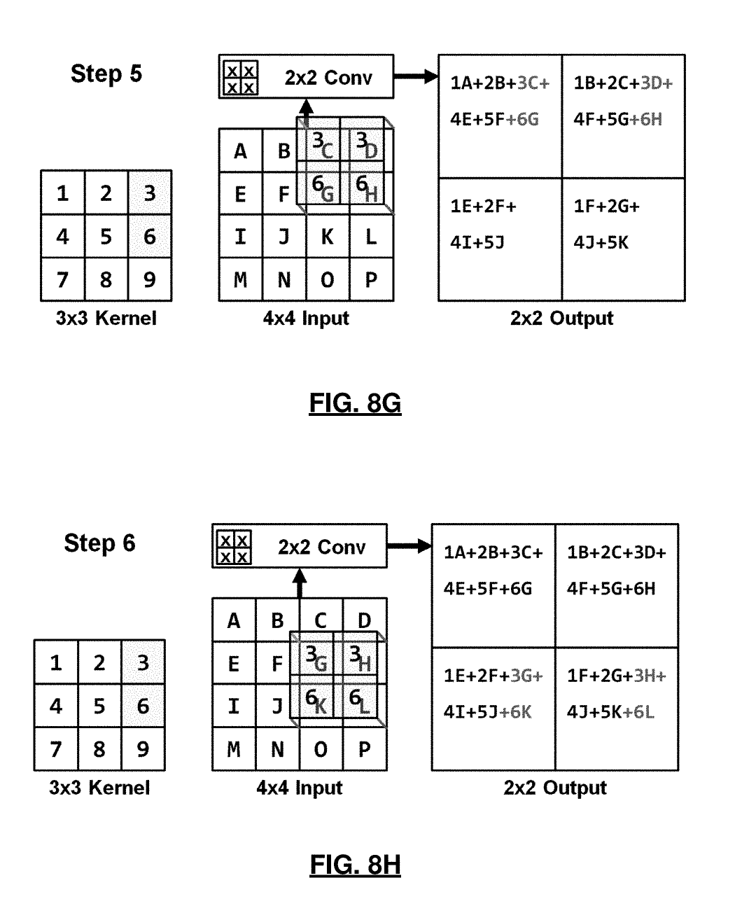

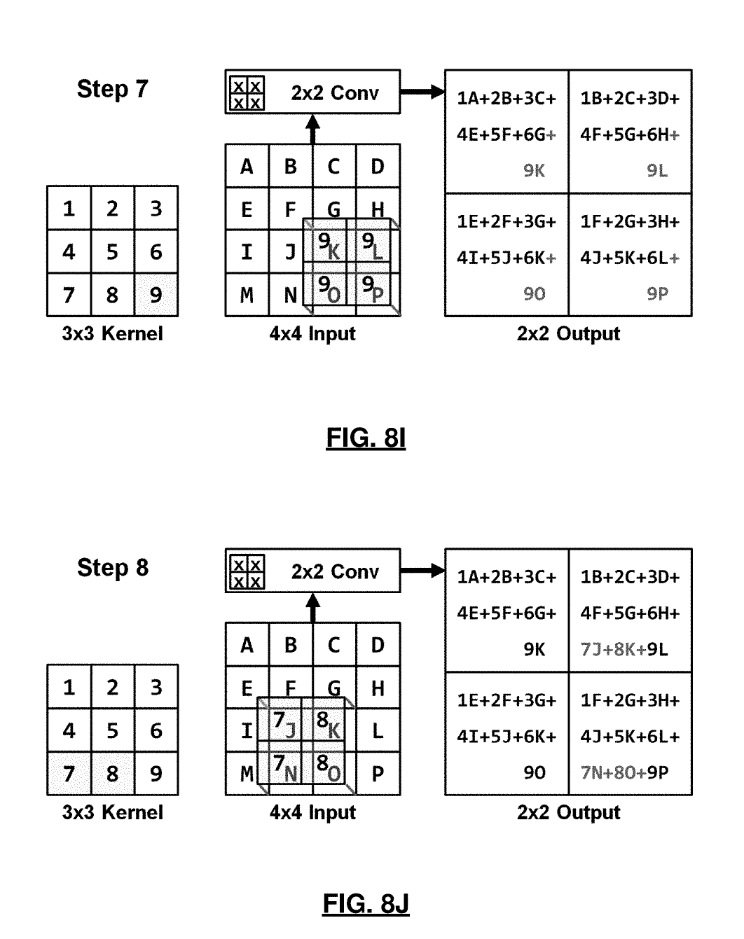

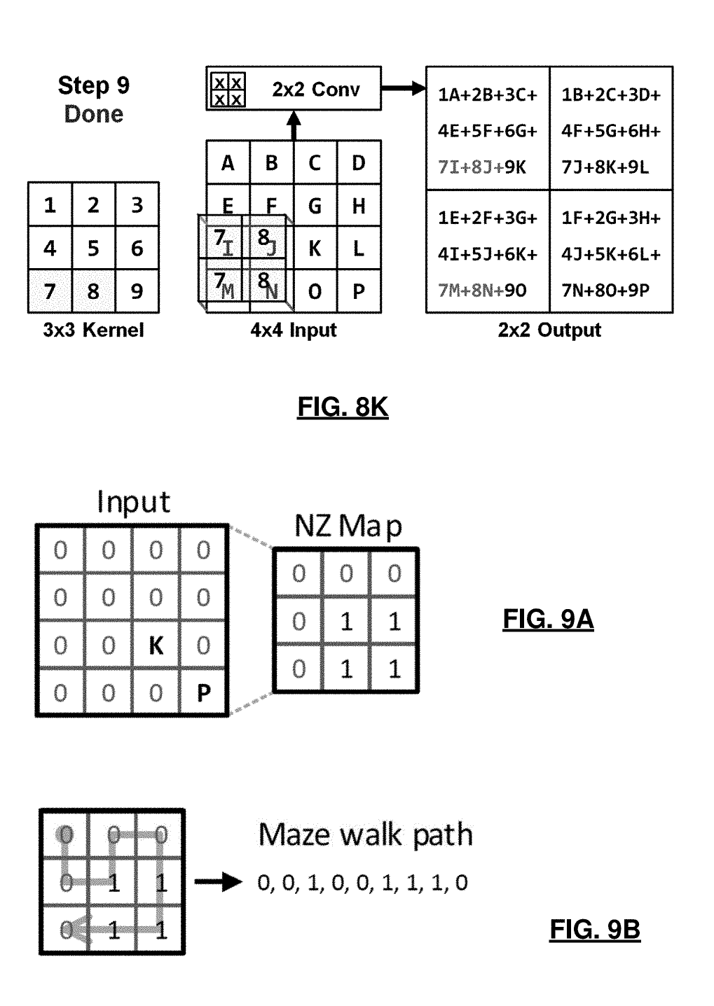

At each step of the walking path, a dot product is computed between a portion of the convolutional kernel and a portion of the given input segment. The result of the dot product is then accumulated into an output buffer. For ease of explanation, this convolution process is described using a 4×4 image convolved with a 3×3 kernel to produce a 2×2 output as seen in FIG. 8A. The walking path for scanning the physical convolution module in relation to the input segment is seen in FIG. 8B.

In this example, the input segment is scanned in nine steps starting with the top left portion of the input segment. In step 1, the dot product is computed for a 4×4 sub-kernel and a 4×4 block of the input segment as seen in FIG. 8C. For this step, the instruction sent by the front-end processor to a neuron is 1*A+2*B+4*E+5*F. The result of the dot product is in turn accumulated in the upper left register of the output buffer. Similarly, the dot product is computed for steps 2, 3 and 4 as seen in FIGS. 8D, 8E and 8F, respectively.

For these steps, the instructions sent by the front-end processor are as follows: 1*E+2*F+4*I+5*J, down one row; 1*F+2*G+4*J+5*K, right one column; and 1*B+2*C+4*F+5*G, up one row.

Referring to FIGS. 8G and 8H, a 2×1 sub-kernel is applied to a set of two 2×1 input column segments. The physical convolution module accumulates output of the two multipliers for each column to the corresponding column in the output buffer. For these steps, the instructions sent by the front-end processor are as follows: 3*C+6*G and 3*D+6*H; and 3*G+6*K and 3*H+6*L, down one row.

In step 7, a 1×1 sub-kernel is applied to a set of four 1×1 input segments as seen in FIG. 8I. The physical convolution module accumulates output of the four multipliers to a corresponding register in the output buffer. For this step, the instruction sent by the front-end processor is as follows: 9*K, 9*O, 9*L, and 9*P.

Lastly, a 1×2 sub-kernel is applied to a set of two 1×2 input row segments as seen in FIGS. 8J and 8K. The physical convolution module accumulates output of the two multipliers for each row into the corresponding row in the output buffer. For these steps, the instructions sent by the front-end processor are as follows: 7*J+8*K and 7*N+8*O; and 7*I+8*J and 7*M+8*N, left one column. From this example, it is readily understood how kernels of different sizes can be partitioned to fit into a physical convolution module having a fixed size.

To maximize throughput, the multipliers in the physical convolution module need to be fully utilized if possible, so the two 2×1 input column segments are processed together by the physical convolution module in steps 5 and 6. Similarly, four 1×1 input segments are processed together in step 7, and two 1×2 input row segments are processed together in steps 8 to 9. The physical convolution module is preferably equipped with a configurable adder tree to handle various forms of accumulation in different steps.

To maximize locality of reference, kernel sections are fetched once and reused until done, and image segments are shifted by one row or column between steps. Such a carefully arranged sequence results in a maze-walking path that maximizes hardware utilization and data locality. An optimal path exists for every kernel size; yet, to minimize storage, paths for larger kernels are created with multiple smaller paths, for example as described above in relation to FIG. 7.

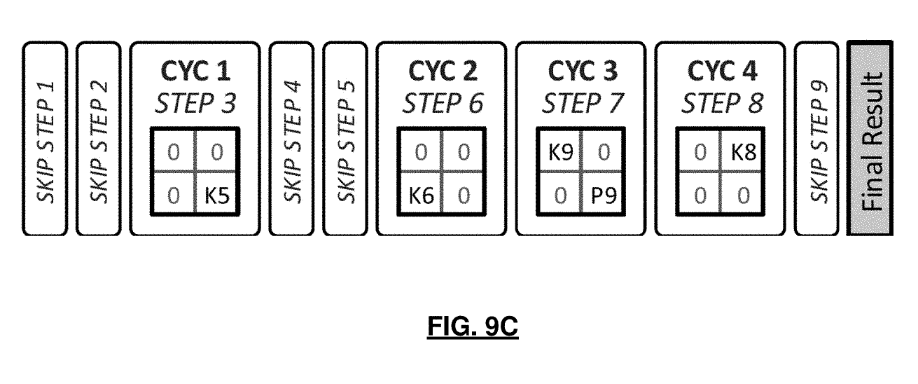

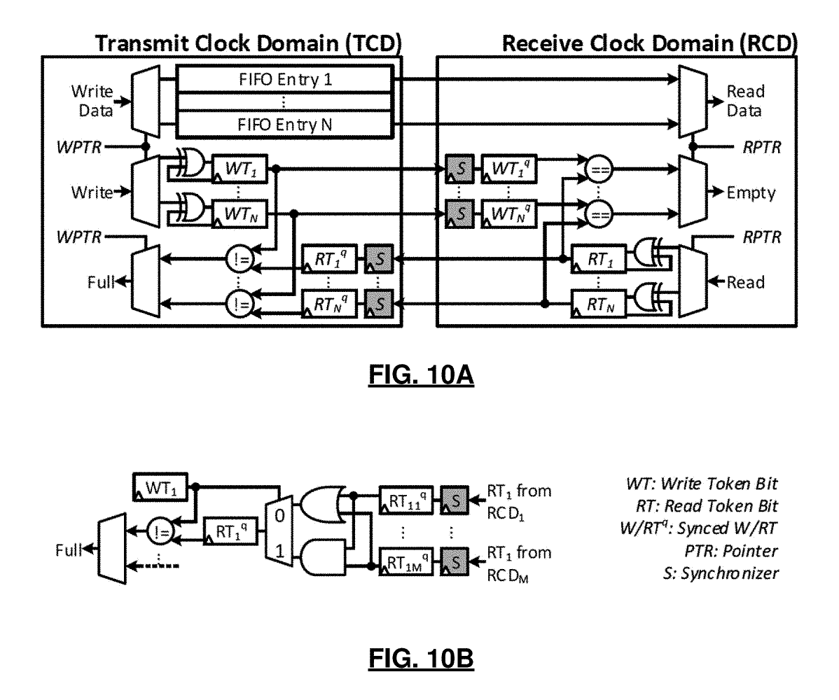

In one aspect of this disclosure, the configurable convolution processor supports sparse convolution for a sparse input to increase throughput and efficiency. It has been observed that it is more likely to have a patch of zeros than a line of zeros in the input, so skipping zero patches is more effective. The configurable convolution processor readily supports zero-patch skipping with the help of an input non-zero (NZ) map, wherein a NZ bit is 1 if at least one nonzero entry is detected in an area covered by a patch of the same size as the physical convolution module. FIGS. 9A-9C show an example in which the NZ map of an image contains two nonzero entries. Guided by the NZ map, the configurable convolution processor skips steps where the NZ bit is 0 to realize sparsity-proportional throughput increase. A hierarchical NZ map, which is a NZ map of multiple NZ maps, can be used to further increase the throughput for very sparse input by skipping an entire input segment containing all 0. Compared with previous works, the configurable convolution processor with zero-patch skipping increases the throughput by up to 40% at 90% input sparsity. The proposed configurable convolution processor with zero patch skipping is equally applicable to deep neural networks.

Triggered by a neuron's spike, the front-end processor performs reconstruction by retrieving the neuron's kernel from the kernel memory and accumulating the kernel in the image memory, with the kernel's center aligned to the spike location. Like in the configurable convolution, a kernel is also divided into sections to support variable kernel size in the spike-driven reconstruction. The NZ map of the reconstructed image is computed by OR'ing the NZ map of the retrieved kernels, saving both computation and latency compared to the naüve way of scanning the reconstructed image. The spike-driven reconstruction eliminates the need to store spike maps. In one embodiment of the design, a 16-entry FIFO is sufficient for buffering spikes, cutting the storage by 2.5×.

In the example embodiment, the configurable convolution processor 10 implements globally asynchronous communication between the front-end-processor and neurons to achieve scalability by breaking a single clock network with stringent timing constraints into small ones with relaxed constraints. The globally asynchronous scheme further enables load balancing by allowing the front-end processor and individual neurons to run at the optimal clock frequencies based on workload. Following feed-forward operations, neurons send 10-bit messages to identify neuron spikes to the hub via a token-based asynchronous FIFO. Following a feedback operation, the hub sends 128-bit messages that contain reconstructed image and NZ map to the neurons. To avoid routing congestion from the hub to the neurons, a broadcast asynchronous FIFO is designed, which is identical to the token-based asynchronous FIFO except for the FIFO full condition check logic.

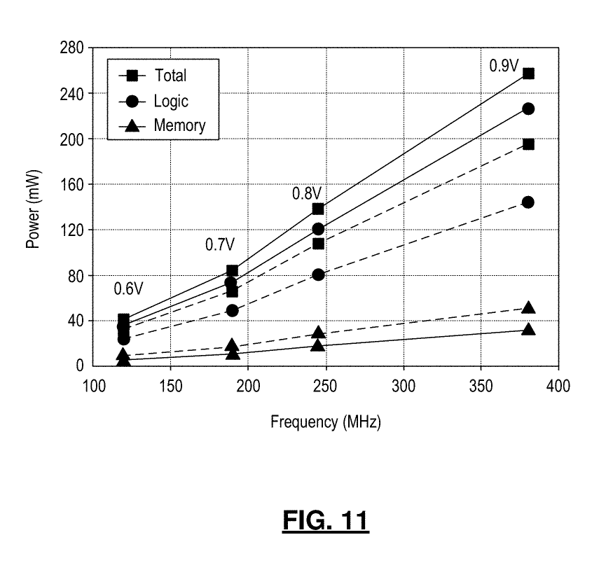

The asynchronous FIFO design is shown in FIG. 10. The token-based asynchronous FIFO is full when the transmit clock domain (TCD) write token disagrees with the synchronized receive clock domain (RCD) read token. The broadcast asynchronous FIFO has multiple RCDs and it is full when the TCD write token disagrees with any synchronized RCD read token. Synchronizer stage in all asynchronous FIFOs are configurable between 2 and 4 stages to accommodate PVT-induced delay variations.

As a proof of concept, a 4.1 mm² test chip is implemented in 40 nm CMOS, and the configurable convolution processor 10 occupies 2.56 mm². A mixture of 80.5% high-V_{T} and 19.5% low-V_{T} cells is used to reduce the chip leakage power by 33%. Dynamic clock gating is applied to reduce the dynamic power by 24%. A balanced clock frequency setting for the hub and neurons further reduces the overall power by an average of 22%. A total of 49 VCOs are instantiated, with each VCO occupying only 250 um² area. The test chip achieves 718 GOPS at 380 MHz with a nominal 0.9V supply at room temperature. An OP is defined as an 8-bit multiply or a 16-bit add.

Two sample applications are used to demonstrate the configurable convolution processor: extracting sparse feature representation of images and extracting depth information from stereo images. The feature extraction task is entirely done by the front-end processor and neurons; and the depth extraction task requires an additional local matching post-processing programmed on the on-chip Open RISC processor. When performing feature extraction using 7×7 kernels, 10 recurrent iterations, and a target sparsity of approximately 90%, the configurable convolution processor 10 achieves 24.6M pixel/s (equivalent to 375 256×256 frames per second), while consuming 195 mW (shown in dashed lines in FIG. 11). In performing depth extraction using 15×15 kernels, 10 recurrent iterations, and a target sparsity of approximately 80%, the configurable convolution processor 10 achieves 7.68 M pixel/s (equivalent to 117 256×256 frames per second) while consuming 257 mW (shown in solid lines in FIG. 11). Compared to the optimal baseline designs without exploiting sparsity, the throughputs of the tasks are improved by 7.7× and 9.7×, respectively. Voltage and frequency scaling measurement shows that at 0.6V supply and 120 MHz clock frequency, the chip power is reduced to 53.9 mW for the feature extraction task and 69.3 mW for the depth extraction task.

Compared to state-of-the-art inference processors based on feedforward only networks, the configurable convolution processor 10 realizes a recurrent network, supports unsupervised learning, and demonstrates expanded functionalities including depth extraction from stereo images, while still achieving competitive performance and efficiency in power and area.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A configurable convolution processor, comprising:
a front-end processor configured to receive an input having an array of values and a convolutional kernel of a specified size to be applied to the input; and
a plurality of neurons interfaced with the front-end processor, each neuron includes a physical convolution module with a fixed size; wherein each neuron is configured to receive a portion of the input and the convolutional kernel from the front-end processor, and operates to convolve the portion of the input with the convolutional kernel in accordance with a set of instructions for convolving the input with the convolutional kernel, where each instruction in the set of instructions identifies individual elements of the input and a particular portion of the convolutional kernel to convolve using the physical convolution module.

2. The configurable convolution processor of claim 1 wherein the front-end processor determines the set of instructions for convolving the input with the convolutional kernel and passes the set of instructions to the plurality of neurons.

3. The configurable convolution processor of claim 2 wherein the front-end processor defines a fixed block size for the input based on the specified size of the convolutional kernel and size of the physical convolution module, divides the input into segments using the fixed block size and cooperatively operates with the plurality of neurons to convolve each segment with the convolutional kernel.

4. The configurable convolution processor of claim 3 wherein convolving each segment with the convolutional kernel further comprises
determining a walking path for scanning the physical convolution module in relation to a given input segment, where the walking path aligns with center of each pixel of the convolutional kernel when visually overlaid onto the convolutional kernel and the walking path aligns with center of the input segment when visually overlaid onto the given input segment;
at each step of the walking path, computing a dot product between a portion of the convolutional kernel and a portion of the given input segment and accumulating result of the dot product into an output buffer.

5. The configurable convolution processor of claim 1 wherein the physical convolution module has a fixed size.

6. The configurable convolution processor of claim 1 wherein the physical convolution module has a fixed size of four by four.

7. The configurable convolution processor of claim 1 wherein the input is further defined as an image having a plurality of pixel values.

8. The configurable convolution processor of claim 1 wherein the front-end processor implements a recurrent neural network with feedforward operations and feedback operations performed by the plurality of neurons.

9. The configurable convolution processor of claim 8 wherein neurons in the plurality of neurons are configured to receive a portion of the input during a first iteration and configured to receive a reconstruction error during subsequent iterations, where the reconstruction error is difference between the portion of input and a reconstructed input from a previous iteration.

10. The configurable convolution processor of claim 9 wherein neurons in the plurality of neurons generate a spike when a convolution result exceeds a threshold, accumulates spikes in a spike matrix, and creates the reconstructed input by convolving the spike matrix with the convolutional kernel.

11. The configurable convolution processor of claim 10 wherein the reconstructed input is accompanied by a non-zero map, such that non-zero entries are represented by a one and zero entries are represented by zero in the non-zero map.

12. The configurable convolution processor of claim 11 wherein, for each step of the path, neurons in the plurality of neurons skip performing a dot product when corresponding entry in the non-zero map is zero.

13. A method for convolving an input with a convolutional kernel in a configurable convolution sparse coding processor, comprising:
providing, by a neuron, a physical convolution module;
receiving, by the neuron, a convolutional kernel of a specified size, where the physical convolution module has a fixed size;
receiving, by the neuron, at least a portion of an input to be convolved with the convolutional kernel, where the input has an array of values;
receiving, by the neuron, a set of instructions for convolving the input with the convolutional kernel, where each instruction in the set of instructions identifies individual elements of the input and a particular portion of the convolutional kernel to convolve using the physical convolution module;
convolving, by the neuron, the portion of the input with the convolutional kernel in accordance with the set of instructions.

14. The method of claim 13 wherein convolving the portion of the input with the convolutional kernel includes
determining a walking path for scanning the physical convolution module in relation to a given input segment, where the walking path aligns with center of each pixel of the convolutional kernel when visually overlaid onto the convolutional kernel and the walking path aligns with center of the input segment when visually overlaid onto the given input segment; and
at each step of the walking path, computing a dot product between a portion of the convolutional kernel and a portion of the given input segment and accumulating result of the dot product into an output buffer.

15. The method of claim 14 wherein computing a dot product further comprises skipping the dot product operation when a corresponding entry in a non-zero map is zero.

16. The method of claim 13 further comprises returning, by the neuron, result from convolving the portion of the input with the convolutional kernel to a front-end processor.

17. The method of claim 16 wherein the front-end processor implements a recurrent neural network with feedforward operations and feedback performed a plurality of neurons.

18. The method of claim 17 further comprises generating, by the neuron, a spike when the result exceeds a threshold;
accumulating, by the neuron, spikes in a spike matrix;
creating, by the neuron, a reconstructed input by convolving the spike matrix with the convolutional kernel; and
returning, by the neuron, the reconstructed input to the front-end processor.

19. The method of claim 13 wherein the input is further defined as an image having a plurality of pixel values.
